(19) United States
(12) Patent Application Publication
(10) Pub. No.: US 2025/0091622 A1
(43) Pub. Date: Mar. 20, 2025

(54) HOLDING DEVICE FOR AN ELECTROMAGNETIC RAIL BRAKE OF A RAIL VEHICLE, AND METHOD FOR OPERATING A HOLDING DEVICE

(71) Applicant: KNORR-BREMSE GESELLSCHAFT MIT BESCHRANKTE HAFTUNG, Moedling (AT)

(72) Inventors: Volker JOERGL, Breitenfurt (AT); Daniel Tippelt, Wiener Neustadt (AT); Michael Kassan, Steinabrueckl (AT); Alexandr Hruby, Moedling (AT); Reinhard Loebner, Munich (DE); Ulrich Wermund, Munich (DE); Jens Galander, Dachau (DE)

(21) Appl. No.: 18/901,421

(22) Filed: Sep. 30, 2024

Related U.S. Application Data
(63) Continuation of application No. PCT/EP2023/059889, filed on Apr. 17, 2023.

(30) Foreign Application Priority Data
Apr. 19, 2022 (DE) DE102022109469.3

(51) Int. Cl. B61H 7/08; B60T 13/58; B60T 13/74; B61H 13/00; F16D 63/00; F16D 121/04; F16D 121/14; F16D 121/20

(52) U.S. Cl. CPC B61H 7/086; B60T 13/588; B60T 13/748; B61H 13/00; F16D 63/008; F16D 2121/04; F16D 2121/14; F16D 2121/20

(57) ABSTRACT

A holding device for an electromagnetic rail brake of a rail vehicle, the holding device comprising: a holding element including a spring configured to support the holding device at a chassis of the rail vehicle; a movable actuation bolt connected with the holding element and couplable with the electromagnetic rail brake; and a hydraulic unit connected with the holding element and the actuation bolt, wherein the hydraulic unit is configured to move the actuation bolt between an idle position in which the electromagnetic rail brake is inactive during operations of the rail vehicle and an active position in which the electromagnetic rail brake is active during operation of the rail vehicle in response to hydraulic fluid flowing into the hydraulic unit or hydraulic fluid flowing out of the hydraulic unit.

### RELATED APPLICATIONS

This application is a continuation of international patent application PCT/EP2023/059889 filed on Apr. 17, 2023 claiming priority from German patent application DE 10 2022 109 469.3 filed on Apr. 19, 2022, both of which are incorporated in their entirety by this reference.

### FIELD OF THE INVENTION

The instant invention relates to a holding device for an electromagnetic rail brake of a rail vehicle and a method for operating the holding device according to the independent claims.

### BACKGROUND OF THE INVENTION

Trams are typically equipped almost exclusively with electromagnetic rail brakes in a mechanical low suspension, 8 mm up to approximately 12 mm above an upper rail edge. These brakes are configured for operating at driving speeds of less than 80 km/h on typical urban rail networks and the design is very simple.

Full size rail vehicles, however, exclusively use electromagnetic rail brakes in a high suspension 40 mm to approximately 110 mm above the upper rail edge. These brakes can be used up to 280 km/h. The suspension is typically configured pneumatic single stage or pneumatic/mechanical two stage. Tram-train composites, thus e.g. street car trolleys typically run most of their travel distance in town as a tram, but can also run longer distances on full size rail tracks going to suburban terminals. This poses substantial challenges for the suspension due to highly divergent requirements. Electromagnetic rail brakes for tram-trains should also be designed so that they comply with urban and cross country standards and can fulfill their function as an emergency brake.

### BRIEF SUMMARY OF THE INVENTION

Thus, it is an object of the invention to provide an option for an improvement of the suspension of an electromagnetic rail brake for a rail vehicle.

The object is achieved by the features of the independent claims.

The instant invention provides a holding device for an electromagnetic rail brake of a rail vehicle, the holding device comprising:
a holding element including a spring configured to support the holding device at a chassis of the rail vehicle,
a moveable actuation bolt connected with the holding element and couplable with the electromagnetic rail brake; and
a hydraulic unit connected with the holding element and the actuation bolt, wherein the hydraulic unit is configured to move the actuation bolt between an idle position in which the electromagnetic rail brake is inactive during operations of the rail vehicle and an active position in which the magnetic rail brake is active during operation of the rail vehicle in response to a hydraulic fluid flowing into the hydraulic unit or hydraulic fluid flowing out of the hydraulic unit.

The spring can be a mechanical spring configured in various forms. The rail vehicle can be in particular a rail car or a locomotive which can be configured with a corresponding electromagnetic rail brake. The actuation bolt can be a rod or a mechanical connecting element that attaches and retains the magnetic rail brake at the actuation bolt. The hydraulic unit can be a hydraulic cylinder which changes its length or a position of the actuation bolt relative to the rail when hydraulic fluid is introduced. The idle position is a position of the actuation bolt in which the electromagnetic rail brake is positioned at a large distance above the rails in an inactive operating position of the electromagnetic rail brake, whereas the actuation bolt brings the electromagnetic rail brake into an active position where the electromagnetic rail brake is positioned at a small distance above the rails in an active operating condition, thus during braking.

This approach is based on the finding that using the hydraulic unit facilitates a very quick and powerful movement of the electromagnetic rail brake. This is important in particular when the electromagnetic rail brake is also to be used for emergency braking of the rail vehicle since a quick reaction to an emergency situation is required so that the electromagnetic rail brake is to be moved from the idle position into the active position quickly. Using a hydraulic unit over the currently used pneumatic unit facilitates transferring high forces since a liquid can be used as the transfer medium that is not compressible so that forced transmission can be performed very efficiently.

In a particularly advantageous embodiment the spring of the holding element is configured as a coil spring. This embodiment has the advantage of using a very compact element with little installation space requirement to implement the spring. Additionally using a coil spring provides good and wide support at the chassis of the rail vehicle.

According to another embodiment of the invention the hydraulic unit can be arranged in an interior of the coil spring. This embodiment of the invention has the advantage of advantageously using the installation space in the interior of the coil spring for the hydraulic unit so that the holding device thus configured requires very little installation space.

According to another advantageous embodiment of the invention an annular buffer element can be used that is arranged around the actuation bolt, wherein the buffer element can be arranged so that part of the chassis is clampable between the annular buffer element and the spring. This embodiment of the invention has the advantage that a portion of the chassis is clampable between the annular buffer element and the spring so that the holding device or the holding elements can be movably attached at the chassis. This way a reliable attachment of the electromagnetic rail brake can be assured even under vibration load and against lateral movements like e.g. during lowering or lifting or also through the impact of dynamic air pressure when the rail vehicle is driving or when braking the rail vehicle.

According to an advantageous embodiment of the invention a support spring is provided and configured to load the actuation bolt with a force so that the actuation bolt is pressed from the idle position into the active position, in particular wherein the support spring is arranged at an end of the actuation bolt, wherein the end is arranged opposite to the hydraulic unit. This embodiment of the invention has the advantage of activating the electromagnetic rail brake reliably and quickly so that resistance against lowering the electromagnetic rail brake caused by environmental impacts can be compensated the best way possible.

According to an advantageous embodiment of the invention the actuation bolt can be formed in plural parts that are supported or supportable moveable and/or pivotable relative to each other. This embodiment advantageously provides additional flexibility for the design of the holding device so that a reliable and possibly rigid attachment of the holding unit at the chassis can be implemented, whereas a flexible support of the electromagnetic rail brake is facilitated in the idle position as well as in the active position.

According to an advantageous embodiment of the invention the hydraulic unit is axially moveable and a second partial element pivotably connected with the first partial element is couplable with the electromagnetic rail brake. This embodiment has the advantage of reliably supporting the first partial element of the actuation bolt so that a quick and precise movement of the electromagnetic rail brake into a nominal position can be assured.

According to another advantageous embodiment of the invention an electromagnetic rail brake unit is used including an embodiment of the holding device according to the invention and an electromagnetic rail brake attached at the actuation bolt. Also this embodiment facilitates achieving the advantages recited supra quickly and efficiently.

According to another advantageous embodiment of the invention a rail vehicle is provided that includes a chassis including an embodiment of the electromagnetic rail brake recited supra, wherein the actuation bolt is run through an opening of a portion of the chassis of the rail vehicle, and/or the electromagnetic rail brake is arranged on a side of a portion of the chassis arranged opposite to the hydraulic unit, wherein the holding unit is attached at the portion of the chassis. This embodiment has the advantage of a moveable and thus flexible attachment of the magnetic rail brake at the chassis which simultaneously assures a reliable and quick movement of the electromagnetic rail brake into a nominal position.

The invention can also be implemented in a method for operating an embodiment of the holding device recited supra, the method comprising:

Introducing a hydraulic fluid into the hydraulic unit and/or draining the hydraulic fluid from the hydraulic unit in order to move the electromagnetic rail brake between the idle position and the active position.

Also this embodiment quickly and efficiently reaps the advantages of the embodiment recited supra.

This method can be implemented e.g. in software or in hardware or in a mix of software and hardware, e.g. in a control unit.

The invention can also be implemented by a control unit configured to perform control or implement the steps of an embodiment of the method recited supra in corresponding arrangements. Also this embodiment of the invention in the form of a control unit achieves the object of the invention quickly and efficiently.

Thus, the control unit can include a computing unit configured to process signals or data, at least one storage unit configured to store signals or data, at least one interface to a sensor or an actuator configured to read sensor signals from the sensor or for putting out control signals to the actuator or at least one communication interface for reading or putting out data wherein the data is embedded in a communication protocol. The computing unit can be e.g. a signal processor, a microcontroller or similar wherein the storage unit is a flash memory, an EEPROM or a magnetic storage unit. The communication interface can be configured to read data wirelessly and/or through a conductor or put out the data, whereas a communication interface that can read or put out the data through a conductor can read this data electrically or optically from a corresponding data transmission conductor or put the data out into a corresponding data transmission conductor.

A control unit can be an electrical unit which processes sensor signals and/or puts out control and/or data signals as a function of the sensor signals. The control unit can include an interface that can be configured in hardware and/or in software. In a hardware embodiment the interfaces can be part of a so called system ASIC which implements various functions of the control unit. However it is also feasible that the interfaces are proper integrated circuits or are at least partially made from discreet components. In a software implementation the interfaces can be software modules which are provided e.g. on a microcontroller together with other software modules.

The invention can also be implemented by a computer program product or a computer program including program code which can be stored on a machine readable carrier or storage medium like e.g. a semiconductor storage or a hard drive storage or an optical storage and used for executing, implementing and/or controlling the steps of the method according to one of the embodiments recited supra in particular when the program is executed on a computer or a device.

### BRIEF DESCRIPTION OF THE DRAWINGS

Embodiments of the invention will be subsequently described with reference to drawing figures, wherein:

FIG. 1 illustrates a schematic view of a bogie of a rail vehicle;

FIG. 2 illustrates a schematic sectional view of an embodiment of a holding device;

FIG. 3 illustrates a schematic sectional view of an embodiment of a holding device;

FIG. 4 illustrates a schematic view of another embodiment of a holding device;

FIG. 5 illustrates a block diagram of a method for operating a holding device; and

FIG. 6a through 6c illustrate schematic sectional views of another embodiment of a holding device.

### DETAILED DESCRIPTION

Like or similar elements are designated with identical or similar reference numerals in the subsequently described drawing figures in order to avoid providing the same description repeatedly.

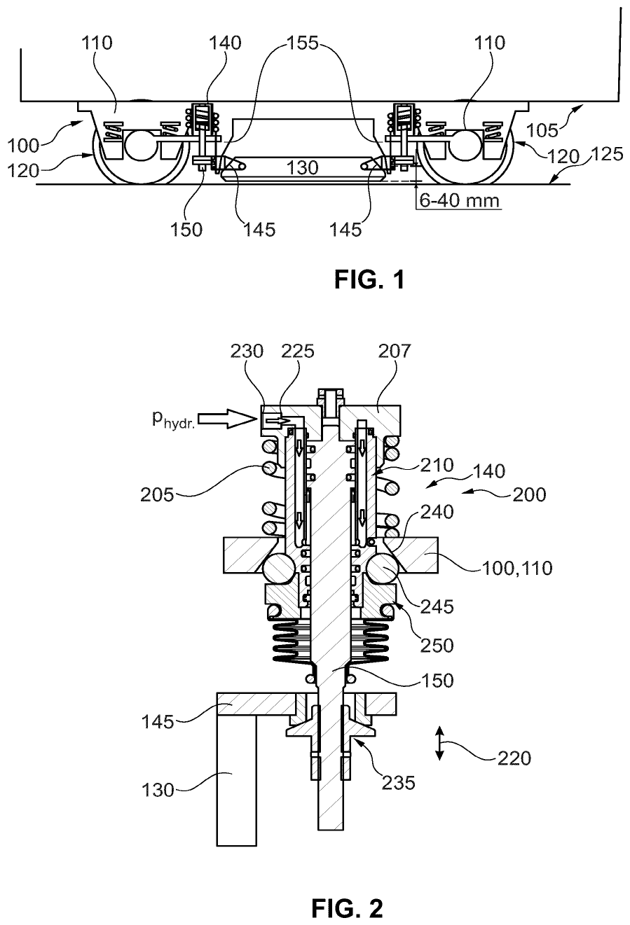

FIG. 1 illustrates a schematic representation of a bogie 100 of a rail vehicle 105. The rail vehicle 105 can be e.g. a rail car. The rail vehicle 105, however, can also be configured as a locomotive. The bogie 100 includes a chassis 110 wherein an axle box 115 is arranged at both ends of the chassis and respectively receives a wheel set unit 120. The wheel set units 120 are thus configured to move the rail vehicle 105 on rails 125 by wheels.

An electromagnetic rail brake 130 is typically used to perform the braking and configured as recited supra to be lowered towards the rail 125 from different elevations and which is either pressed onto the rail 125 directly or generates Eddy currents and thus generates a brake force impacting the rail vehicle. This can be implemented e.g. in that an electrical current is caused to flow through the electromagnetic rail brake 130, so that the electromagnetic rail brake 130 magnetically interacts with the rails 125 typically made from steel and thus ferro magnetic rails, so that the electromagnetic rail brake 130 is pressed onto or at least in a direction towards the rails 125. FIG. 1 does not explicitly show an electrical connection of the electromagnetic rail brake 130 since this is not part of the core of the invention and would thus distract from the clarity of FIG. 1.

In order to be able to bring the electromagnetic rail brake 130 into a position proximal to the rail 125 quickly in order to be able to perform emergency braking a variant of the holding device 140 is being used which represents e.g. a two stage hydraulic and mechanical actuator. The electromagnetic rail brake 130 is connected through a support arm 145 with an actuation bolt 150 of the holding device 140 and can be positioned according to the embodiment illustrated in FIG. 1 at different elevations of e.g. 6 mm up to 40 mm above the rail 125. The individual end points of this movement path can thus correspond to the active position, e.g. 6 mm above the rail 125 or the idle position, e.g. 40 mm above the rail 120. Lateral support elements 155 can be provided in order to assure safe support of the electromagnetic rail brake 130 within the movement path, wherein the lateral support elements prevent a lateral or horizontal movement of the electromagnetic rail brake 130 so that merely a vertical movement of the electromagnetic rail brake 130 in a direction towards the rail 125 or away from the rail 125 is performed in a manner stabilized by the holding device 140.

FIG. 2 shows a sectional view of an embodiment of a holding device 140. The holding device thus includes a holding element 200 that includes a spring 205. The spring 205 is thus configured as a compression coil spring and supported on one side on a top side of the bogie 100 or the chassis 110 and on the other side at a headpiece 207 of the holding unit 200. The holding device 140 additionally includes a hydraulic unit 210 which is arranged in an interior of a coil spring 205 in the embodiment illustrated in FIG. 2. This way the hydraulic unit 210 requires very little installation space. The hydraulic unit 210 can act e.g. as a hydraulic cylinder and cause a vertical movement of the electromagnetic rail brake 130 in cooperation with the actuation bolt 150. Thus, the hydraulic unit 110 renders the actuation bolt 150 moveable in a vertical movement direction 220 as a function of a hydraulic fluid 225 with a pressure p_{hydr} being introduced at a connection 230 of the hydraulic unit 210 arranged at a headpiece 207 or drained from the hydraulic unit 210. The support arm 145 is attached at a lower end of the actuation bolt 150, e.g. by a nut or by a locking device, wherein the electromagnetic rail brake 130 is fixed at the support arm 145 as schematically illustrated in FIG. 2.

The axis of the actuation bolt 150 can be configured laterally moveable in order to facilitate a certain amount of lateral or horizontal movability of the support arm 145 or the electromagnetic rail brake 130, e.g. in order to receive brake forces and thus avoid excessive loading of the material. Thus, the bogie 100 or the chassis 110 can include a cone shaped opening 240 wherein an upper end of the opening oriented towards the spring 205 has a smaller opening cross section than an opening cross section of the opening 240 oriented away from the spring 205. Using an annular buffer 245 which is supported e.g. by a flange 250 from below wherein the flange 250 is attached at the actuation bolt 150, the effect of the spring 205 facilitates pressing or loading the annular buffer 245 into the opening 240 and retaining the annular buffer therein. The annular buffer 245 can be made from an elastic material e.g. rubber, natural rubber or similar and can be configured not to be crushed and damaged even by large forces that are being received. When the support arm 145 is displaced horizontally or laterally as illustrated in FIG. 2 these displacement forces can be received by a lateral pivoting of the actuation bolt 150 which compresses the annular buffer 245 slightly more on one side of the opening 240 than on another side of the opening. The elasticity of the material of the annular buffer 245 assures a spring back of the actuation bolt 150 into its original orientation.

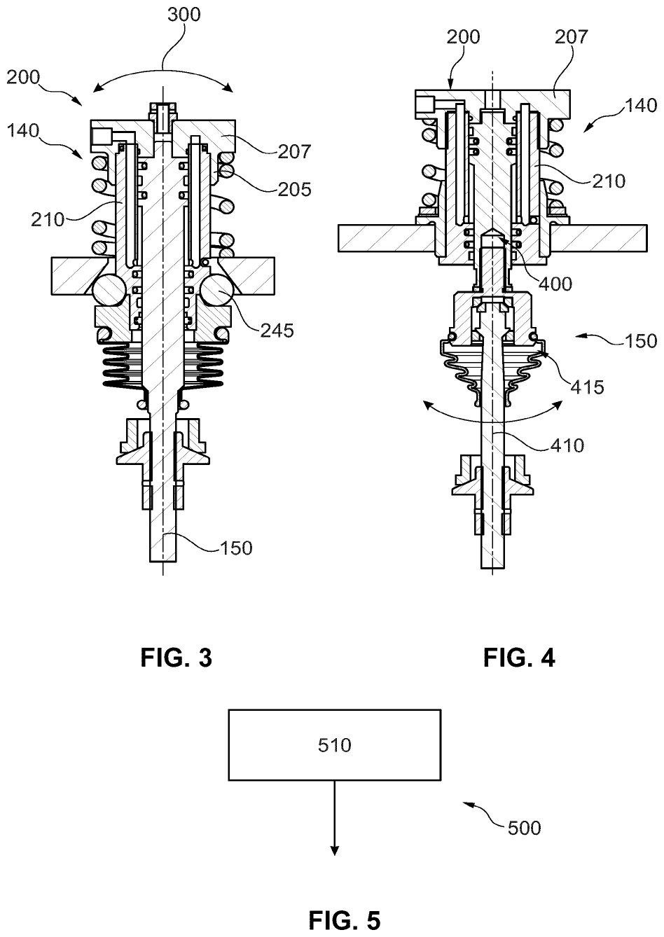

FIG. 3 illustrates a schematic sectional view of the embodiment of the holding device 140 already illustrated in FIG. 2. It is evident from the representation according to FIG. 3 that the holding device 140 is able to perform a corresponding pivoting movement due to the flexible support by the annular buffer 245. Thus, also the hydraulic unit 210 is fixed at the actuation bolt 150, but flexibly or moveably supported relative to the headpiece 207, so that the hydraulic unit can move the actuation bolt 150 including the annular buffer 245 when hydraulic fluid is introduced. The headpiece 207 of the holding unit 200 is supported by the spring 205 in this embodiment.

FIG. 4 shows an alternative embodiment of the holding device 140. No annular buffer 245 is provided compared to the embodiment of the holding device illustrated in FIGS. 2 and 3, but the hydraulic unit 210 is connected in a rigid manner with the headpiece 207 of the holding unit 200. The actuation bolt 150 is configured in two components in order to facilitate a lateral or horizontal movement of the electromagnetic rail brake 130. Thus, an upper first partial element 400 is fixed in a rigid manner at the hydraulic unit 210. A second partial element 410 of the actuation bolt 150 is connected laterally pivotable by a joint 415. When introducing a hydraulic fluid into the hydraulic unit 210 the first partial element 400 is pressed downward, thus in a direction towards the rail and the second partial element 110 is also pressed downward towards the rail. This facilitates a lateral movement by a movement of the second partial element 110 in the joint 415.

The great advantage of using the hydraulic unit 210 is the ability to perform a movement of the electromagnetic rail brake 130 with high velocity and thus with a short reaction time. The reason is that raising and lowering the electromagnetic rail brake 130 can be performed with a greater force when using a hydraulic solution compared to a pneumatic solution since forced transmission through a liquid is more efficient since the liquid is not compressible which also avoids compression losses. Modern rail vehicles typically already include a hydraulic system so that implementing the invention only requires minor engineering changes in the rail vehicle.

Summing it all up electromagnetic rail brakes are typically used worldwide in trams, full-size rail vehicles e.g. regional trains or inter-city trains or are typically also used in so called train-train applications as an emergency brake. The magnetic rail brakes typically only include one magnet and a suspension forming an interface with the vehicle. Thus, typical requirements for the rail brake include:
low weight
low installation space required in suspension/bogie

rapid build up of the brake force by very quick lowering of the magnets to the rail
compatibility with boundary conditions provided by the vehicle environment, pre-existing media for control and force generation, electromagnetic compatibility with adjacent vehicle components,
compatibility with a surrounding rail infrastructure, electromagnetic compatibility with existing track clearance reporting systems and light space profiles.

It is appreciated that using mechanical low suspensions is also possible on full size train tracks taking advantage of the weight and installation space advantages and the low drop duration when activating the brakes, however the following aspects need to be considered:
appropriately configured rail infrastructure, e.g. compatible rail clearance reporting technology
modified suspension that assures a large air gap between the switched off magnet and the rail. Thus suspension elevations of up to approximately 20 mm are technically feasible today using a two stage mechanical/mechanical installation
mechanical compensation of wear by an actuation bolt
modified electromagnetic rail brake magnets. Thus, mechanical attachments e.g. magnetic field guidance plates are used at the magnet.

Embodiments of the invention solve the following problems:

### Prior Art, Typically Used in Tram-Train Vehicles

limits an area of operation of the vehicle to explicitly certified track sections. This leads to substantial additional effort and additional expense in vehicle certification and is therefore to be avoided from an operator point of view.
improves compatibility of a rail brake in a low suspension with the rail infrastructure, but does not provide enough safety reserve against incompatibility. Thus, additional track section dependent certifications of the vehicle cannot be avoided.

It is furthermore appreciated that using a pneumatic high suspension is also possible for tram-train vehicles, however, this has the following disadvantages:
requirement of compressed air in the bogie for pressurizing and venting the pneumatic cylinders
requirement of installation space for a connection of the pneumatic cylinders
high weight of the pneumatic suspension including its control

### (Compressed Air Supply)

low drop velocity and thus long response time of the rail brake is not acceptable for in-town operations with very short emergency braking distances
for a high suspension the safe position today is always the high position.

Using a two-stage pneumatic/mechanical suspension is also possible for tram-train vehicles, but has the subsequent disadvantages:
requirement of compressed air in the bogie for pressurizing and venting the pneumatic annular buffer elements in a hydraulically braked vehicle
provision of the installation space required for connecting the annular buffer elements
high weight of the pneumatic suspension including its control

### (Compressed Air Supply)

low drop velocity of the pneumatic annular buffer elements and thus long response time of the rail brake is a disadvantage for in-town operations with very short emergency stopping distances.

The tram-train vehicles can be configured with pneumatic braking and also with hydraulic braking from an installation point of view and due to the high power density the compact hydraulic brake according to the invention has significant advantages.

The invention relates to a novel suspension for an electromagnetic rail brake especially, but not exclusively advantageous for applications in tram-train vehicles. The problem to be solved is providing a suspension that functions in-town and cross country as required without any problems.

The object to be achieved by the invention can be to provide a compact, light and quickly responding suspension for rail brakes for rail vehicles which complies with requirements of in-town and cross country operations. A particular aspect of the invention using hydraulic high/low suspension is providing a mechanically adjustable actuation bolt which supports the electromagnetic rail brake in the high position by additional application of hydraulic pressure when the electromagnetic rail brake is at idle.

This takes advantage of the fact that a hydraulic pressure in vehicles is always many times higher than a pneumatic pressure. Therefore it also becomes possible to keep the required installation space low when using the hydraulic unit. Thus, it is an important advantage over a pneumatic cylinder that the hydraulic cylinder can be positioned within the spring as an additional actuator which does not cause any increase in a required width of the suspension.

The external preloaded compression spring is used e.g. for supporting the magnet in the operating position and is limited by the annular buffer element. The operating position is a position from which the electromagnet can retract when a voltage is applied to the rail so that an electromagnetic field is generated. An additional high position of the magnetic is reached in that the inner actuation bolt is retained in the upper idle position by applying the hydraulic pressure. Thus, the operating position is only reached when no hydraulic pressure is provided. This also assures that the electromagnetic rail brake remains operational when the hydraulic pressure fails.

FIG. 5 shows a block diagram of an embodiment of a method 500 for operating a variant of the holding device presented herein. The method 500 includes a step 510 of introducing a hydraulic fluid into the hydraulic unit and/or draining the hydraulic fluid from the hydraulic unit in order to move the electromagnetic rail brake between the idle position and the active position.

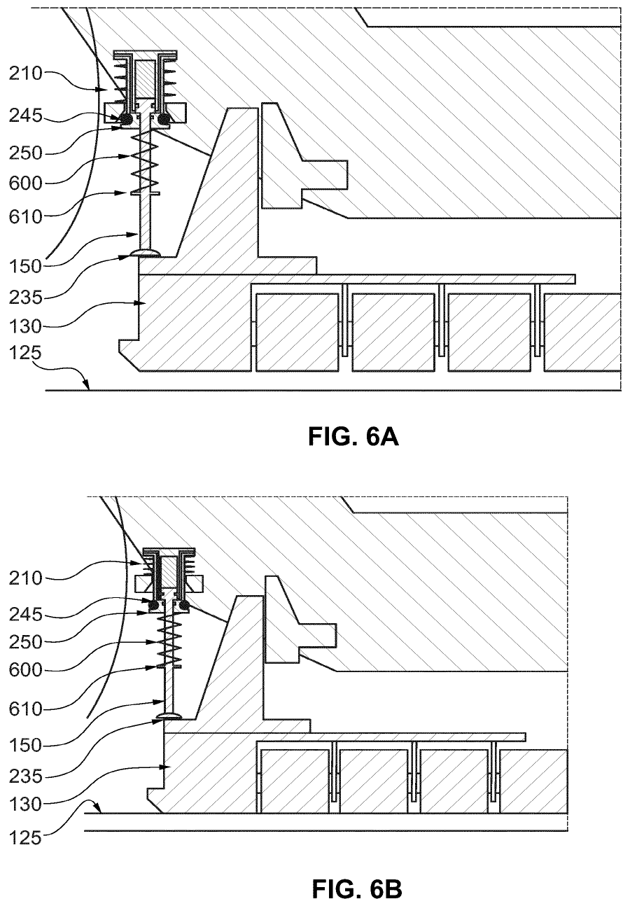

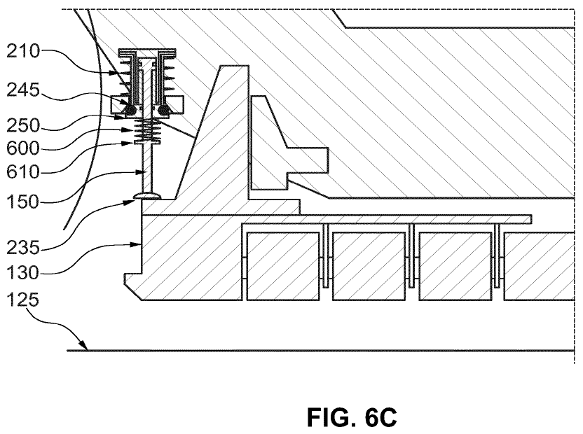

FIGS. 6A through 6C show schematic sectional views of a part of another embodiment of the instant invention. In addition to the components of the holding device 140 as illustrated in FIG. 2 a support unit 600 e.g. configured as a spring is provided, wherein the support unit 600 is installed between the flange 250 and a support element 610 or the attachment element 235 for attaching the magnetic rail brake 130. The support element 610 can be arranged in a portion of the actuation bolt 150 that is oriented away from the hydraulic unit 210, or in a portion between the attachment element 235 and the flange 250.

FIG. 6A thus shows a condition of the holding device 140 in which the actuation bolt 150 is positioned in the hydraulic unit 210 at a lower end, where the actuation bolt 150, however, has not yet reached the active position where the electromagnetic rail brake 130 is pressed onto the rail 125.

FIG. 6B now shows an additional condition of the holding device 140. Thus, an additional force is imparted upon the actuation bolt 150 by the support unit 600, so that the annular buffer element 245 is also deflected downward, so that the electromagnetic rail brake 130 is now pressed onto the rail 125 into the active position and can be operated in this condition e.g. in a brake mode.

FIG. 6C, however, shows a condition in which the holding device 140 is in a retracted condition and the electromagnetic rail brake is moved into the idle position. In this condition the actuation bolt 150 has been moved into an upper position by the hydraulic unit 210 so that the spring is preloaded as the support unit 600 and the electromagnetic rail brake 130 is in a position where it is at the largest distance from the rail 125.

It is also conceivable that the support unit 600 is not attached at a lower portion of the actuation bolt 150 as illustrated in FIGS. 6A through 6C. The support unit 600 can also be arranged as a spring inside the hydraulic cylinder of the hydraulic unit 210, however, the support unit should be arranged in the holding device or at the holding device 140 so that the spring is configured to impart a force upon the actuation bolt 150 so that the actuation bolt 150 is pressed from the idle position into the active position. It is also conceivable that the support unit 600 is configured as an additional hydraulic unit which facilitates an acceleration when lowering the electromagnetic rail brake 130 so that a quicker brake action can be achieved.

Reaching the operating position of the electromagnetic rail brake 130 can thus be additionally supported by an internal support spring configured as a support unit 600 in the hydraulic cylinder or by an externally arranged spring configured as the support unit 600 (e.g. under the annular buffer unit), or by a hydraulic unit. An additional force imparted by a spring or by hydraulics increases a drop velocity from the upper position, this means idle position into the operating position. Influencing the externally arranged preloaded compression spring, thus the spring 205 that supports the electromagnetic rail brake in the operating position therefore does not occur.

In an advantageous embodiment the support unit 600 can be configured as an external spring below the annular buffer unit as illustrated in FIGS. 6A through 6C. The hydraulic piston or the actuation bolt 150 is pressed upward by the hydraulic fluid in the idle position as illustrated in FIG. 6C for the condition of positioning the electromagnetic rail brake 130 in the idle position. The compression spring configured as the support unit 600 below the buffer unit or the annular buffer 245 is thus compressed. When the piston or the actuation bolt 150 is not loaded by the hydraulic pressure of the hydraulic unit 210 anymore, the piston or the actuation bolt 150 is completely extended under its own weight and under the force of the support unit 600, thus the spring, as illustrated in FIG. 6A or in a subsequent step illustrated in FIG. 6B. Thus, the electromagnetic rail brake 130 very quickly reaches the operating position. The external spring configured as the support unit 600 is compressed by the magnetic force in order to reach the brake position or the operating position. The piston or the actuation bolt 150 remain unchanged in the completely extended position as illustrated in FIG. 6A. The extension movement of the piston or the actuation bolt 150 can be generated by a support unit 600 as illustrated, wherein the support unit is arranged e.g. below the buffer unit or below the annular buffer 245 and configured as a spring or by a spring above the piston or by a hydraulic force.

Reference numerals and designations

| | |
|---|---|
| 100 | bogie |
| 105 | rail vehicle |
| 110 | chassis |
| 115 | axle box |
| 120 | wheel set |
| 125 | rail |
| 130 | electromagnetic rail brake |
| 140 | holding device |
| 145 | support arm |
| 150 | actuation bolt |
| 155 | support element |
| 200 | holding element |
| 205 | spring |
| 207 | headpiece |
| 210 | hydraulic unit |
| 220 | vertical movement direction |
| 2258 | hydraulic fluid |
| 230 | hydraulic connection |
| 235 | nut, connection element |
| 240 | opening |
| 245 | annular buffer element |
| 250 | flange |
| 300 | pivot direction |
| 400 | first part of actuation bolt |
| 410 | second part of actuation bolt |
| 415 | joint |
| 500 | control method |
| 510 | introduction step |
| 600 | support unit |
| 610 | support element |

What is claimed is:

1. A holding device for an electromagnetic rail brake of a rail vehicle, the holding device comprising:
a holding element including a spring configured to support the holding device at a chassis of the rail vehicle;
a movable actuation bolt connected with the holding element and couplable with the electromagnetic rail brake; and
a hydraulic unit connected with the holding element and the actuation bolt,
wherein the hydraulic unit is configured to move the actuation bolt between an idle position in which the electromagnetic rail brake is inactive during operations of the rail vehicle and an active position in which the electromagnetic rail brake is active during operation of the rail vehicle in response to hydraulic fluid flowing into the hydraulic unit or hydraulic fluid flowing out of the hydraulic unit.

2. The holding device according to claim 1, wherein the spring of the holing element is configured as a coil spring.

3. The holding device according to claim 2, wherein the hydraulic unit is arranged in an interior of the coil spring.

4. The holding device according to claim 2, further comprising: an annular buffer element arranged about the actuation bolt,
wherein the annular buffer element is arranged so that a part of the chassis is clamped or clampable between the annular buffer element and the spring.

5. The holding device according to claim 1, further comprising: a support unit configured to impart a force upon the actuation bolt so that the actuation bolt is moved from the idle position into the active position,
wherein the support unit is arranged at an end of the actuation bolt arranged opposite to the hydraulic unit and/or at a support element configured to attach the support unit.

6. The holding device according to preceding claim 1, wherein the actuation bolt is configured in plural partial elements supported or supportable moveable and/or pivotable relative to each other.

7. The holding device according to claim 6, wherein a first partial element of the actuation bolt is axially movable by the hydraulic unit and a second partial element of the actuation bolt pivotably connected with the first partial element is couplable with the electromagnetic rail brake.

8. An electromagnetic rail brake unit, comprising:
the holding device according to claim 1; and
an electromagnetic rail brake attached at the actuation bolt.

9. A rail vehicle, comprising:
a chassis; and
the electromagnetic rail brake unit according to claim 7,
wherein the actuation bolt is run through an opening of a portion of the chassis of the rail vehicle, and/or
wherein the electromagnetic rail brake is arranged on a side of a portion of the chassis arranged opposite to the hydraulic unit wherein the holding device (140) is attached at the portion of the chassis.

10. A method for operating the holding device according to claim 1, the method comprising:
introducing a hydraulic fluid into the hydraulic unit and/or draining the hydraulic fluid from the hydraulic unit to move the electromagnetic rail brake between the idle position and the active position.

11. A computer program product including program code configured to control and/or execute the step of the method according to claim 10 when executing the computer program on a computer.

12. A control unit configured to perform, control, or implement the steps of the method according to claim 10 in an accordingly configured arrangement.
